(19) United States
(12) Patent Application Publication
(10) Pub. No.: US 2009/0148540 A1
(43) Pub. Date: Jun. 11, 2009

(54) Antibacterial composition and method of production

(75) Inventors: William John Martin, South Pasadena, CA (US); Stephen Benet Palmer, Saint Louis, MO (US)

Correspondence Address: William John Martin, 1634 Spruce Street, South Pasadena, CA, 91030, US

(73) Assignee: MI HOPE INCORPORATED, SOUTH PASADENA, CA (US)

(21) Appl. No.: 12/001,344

(22) Filed: Dec. 10, 2007

(51) Int. Cl. A01N 59/20; A01P 1/00

(52) U.S. Cl. 424/638

(57) ABSTRACT

An electrolysis method is described for generating an aqueous solution of copper citrate that has bacteriocidal activity against methicillin resistant Staphylococcus aureus (MRSA) bacteria. Gram positive bacteria are known to be relatively more sensitive to the bacteriocidal activities of copper ions than are Gram negative bacteria. Situations exist in which a disinfectant that is relatively more toxic for Gram positive bacteria will be advantageous over a more broadly active disinfectant, such as that provided by most other disinfectants. In particular, a disinfectant that is relatively selective for Gram positive bacteria could help preserve various non-pathogenic Gram negative microbial populations. The residual Gram negative bacteria can potentially compete with, and thereby lessen the chances of the reintroduction of pathogenic Gram positive bacteria, such as MRSA, Streptococcus, Clostridium difficile and Listeria monocytogenes.

### CROSS REFERENCE TO RELATED APPLICATIONS

### UNITED STATES ISSUED PATENTS

U.S. Pat. No. 4,055,655 Complexes of heavy metal ions and polyfunctional organic ligands used as antimicrobial agents
U.S. Pat. No. 5,017,295 Divalent silver bactericide for water treatment
U.S. Pat. No. 5,464,559 Composition for treating water with resin bound ionic silver
U.S. Pat. No. 6,093,414 Silver-based antimicrobial compositions
U.S. Pat. No. 6,197,814 Disinfectant and method of making
U.S. Pat. No. 6,214,299 Apparatus and method for producing antimicrobial silver solution
U.S. Pat. No. 6,294,186 Antimicrobial compositions comprising a benzoic acid analog and a metal salt
U.S. Pat. No. 6,583,176 Aqueous disinfectant
U.S. Pat. No. 6,838,095 Ionic silver complex
U.S. Pat. No. 7,060,302 Metal-containing compositions, preparations and uses
U.S. Pat. No. 7,135,195 Treatment of humans with colloidal silver composition.
U.S. Pat. No. 7,163,709 Composition for disinfection of plants, animals, humans, byproducts of plants and animals and articles infected with pathogens and method of producing and application of same
U.S. Pat. No. 7,192,618 Antimicrobial composition for pre-harvest and post-harvest treatment of plants and animals

### UNITED STATES PENDING PATENT APPLICATIONS

20020123523 Disinfectant and method of making
20020185199 Antimicrobial coated metal sheet
20030198689 Disinfectant and method of making
20050202066 Silver dihydrogen citrate compositions comprising a second antimicrobial agent
20020123523 Disinfectant and method of making
20050247643 Process for treating water
20060051430 Silver dihydrogen citrate compositions
20060115440 Silver dihydrogen citrate compositions
20070185350 Anhydrous silver dihydrogen citrate compositions
20070269530 DISINFECTANT AND METHOD OF MAKING

### OTHER REFERENCES

Richards R M E. Antimicrobial Action of Silver Nitrate, Microbios 31: 83-91, 1981.
Pal B, Heda B I D, Khadikar P V, Kaskedikar S G. Antimicrobial activity of metal chelates of salicyclic acid, Indian J Microbiol. 21: 331-334, 1981.
Peeters M, Vanden Berghe D, Meheus A. Antimicrobial activity of seven metallic compounds against penicillinase producing and non-penicillinase producing strains of Neisseria gonorrhoeae. Genitourin Med. 62:163-5, 1986
Yahya M T, Landeen L K, Messina M C, Kutz S M, Schulze R, Gerba C P Disinfection of bacteria in water systems by using electrolytically generated copper:silver and reduced levels of free chlorine. Can J Microbiol. 36:109-16, 1990.
de Veer I, Wilke K, Rüden H. [Bacterial reducing qualities of copper-containing and non-copper-containing materials. I. Contamination and sedimentation in humid and dry conditions] Zentralbl Hyg Umweltmed. 195:66-87, 1993.
A.D. Russell, F. R. C. Path, F. R. Pharm. W. B. Hugo, Antimicrobial Activity and Action of Silver, Progress in Medicinal Chemistry. 31: 351-370, 1994.
Zimmerman L. Toxicity of Copper and Ascorbic Acid to Serratia marcescens. J Bacteriol. 91: 1537-1542, 1966.
Noyce J O, Michels H, Keevil C W. Potential use of copper surfaces to reduce survival of epidemic meticillin-resistant Staphylococcus aureus in the healthcare environment. J Hosp Infect. 63:289-97, 2006.
Maresso A W, Schneewind O. Iron acquisition and transport in Staphylococcus aureus. Biometals. 19:193-203, 2006.
Hwang M G, Katayama H, Ohgaki S Accumulation of copper and silver onto cell body and its effect on the inactivation of Pseudomonas aeruginosa. Water Sci Technol. 54:29-34, 2006.
Gant V A, Wren M W, Rollins M S, Jeanes A, Hickok S S, Hall T J. Three novel highly charged copper-based biocides: safety and efficacy against healthcare-associated organisms. J Antimicrob Chemother. 60:294-9, 2007.
Borkow G, Gabbay J. Putting copper into action: copper-impregnated products with potent biocidal activities. FASEB J. 18:1728-30, 2004.
Dell'amico E, Mazzocchi M, Cavalca L, Allievi L, Andreoni V. Assessment of bacterial community structure in a long-term copper-polluted ex-vineyard soil. Microbiol Res. 2007 Epub ahead of print.

### STATEMENT REGARDING FEDERALLY SPONSORED RESEARCH OR DEVELOPMENT

No Federal funding was received in support of research covered in this patent application.

### BACKGROUND OF THE INVENTION

The presence of pathogenic bacteria in the environment is being increasingly recognized as a major threat to the health of mankind. Of particular concern is the increasing prevalence of toxic bacteria that can cause illnesses in previously healthy individuals. A prime example is the emergence of toxic strains of methicillin resistant Staphylococcus aureus (MRSA). Staphylococcus aureus bacteria are among the most common cause of both superficial skin infections and deep tissue infections in both man and animals. Drs. Panton and Valentine were among several early investigators who noted that occasional isolates of Staphylococcus aureus were exceptionally virulent because they secreted a tissue toxin that was able to kill leukocytes. This toxin is appropriately referred to as PVL for Panton-Valentine-Leukocidin.

Mankind's battle with Staphylococcus aureus has gone through various phases over the last 50 years. The production of penicillin led to a marked reduction in infections but this success was relatively short lived as more isolates became penicillin resistant by acquiring a plasmid coding for penicillinase. This problem was addressed by the synthesis of methicillin, a penicillinase resistant penicillin analog. With time, methicillin resistance began to appear among Staphylococcus aureus. MRSA infections were, however, mainly confined to individuals with preexisting illnesses, especially hospitalized patients. The major medical challenge with these bacteria has been the development of resistance to an increasing number of additional antibiotics, including vancomycin, previously considered the antibiotic of last resort.

Reports began appearing in 1992 of toxic isolates of MRSA that were causing severe infections in individuals with no known prior risk factors. Some of these isolates were shown to have acquired the gene coding the PVL toxin. Various additional toxins have also been recognized that can add to the aggregate virulence of these toxic strains of MRSA. Presently, the toxic MRSA are still susceptible to a variety of antibiotics but it is predictable that multi-drug resistant toxic MRSA will appear shortly and pose a major threat to humans as well as animals.

Along with many other bacteria, MRSA can survive within the environment for extended periods of time. Infected environments allow for the indirect human to human transmission of infections as well as infections between animals and humans. Bacteria can be readily detected on commonly touched surfaces within homes, workplaces, schools, recreational facilities, shops and other places where the public congregate. Reducing the risk of environmentally contracted infectious diseases is a major Public Health priority.

### PRIOR ART

Various disinfectants are used to periodically reduce the levels of contaminating bacteria in the environment. Alcohol, quaternary ammonium and related compounds are antibacterial but with relatively limited potency in the presence of extraneous material such as dust or organic matter. Bleach, hydrogen peroxide, chlorine dioxide, ozone and other oxidizing agents are stronger disinfectants but are somewhat corrosive and have relatively short term activity. Phenol based products can have longer activities but are considered somewhat toxic and can have unpleasant odors. Metal ions, especially silver, can kill many bacteria and increasingly silver based disinfectants are finding commercial uses. A problem that has been addressed is the relative instability of free silver ions, delivered either alone or in highly dissociable salts, such as silver nitrate as used in newborn nurseries. Carboxylates derived from organic acids, such as citric and ascorbic, can form ionic bonds with silver providing more stable solutions. So too can organic salicylic acid, benzoic acid, etc.

Colloidal silver metal can act as a continuous reservoir of silver ions, as can silver incorporated into zeolite particles. Electrolysis can be used to generate both free silver ions as well as larger colloidal particles. Mostly silver electrodes are used in water with a minimal salt concentration to allow for the flow of electricity. Recent improvements have included the addition of oxygen to provide a minimal surface coating of silver oxide that can help maintain a more dispersed colloidal solution. Electrolysis of silver can also be performed directly within organic acid solutions to create organic silver compounds with greater solubility and silver content that similar compounds created by chemical exchange reactions with inorganic silver compounds.

Copper surfaces have been noted to be relatively selectively toxic for Gram positive bacteria, including Staphylococcus aureus. Similarly, in copper contaminated environments, there is a relative paucity of Gram positive, compared with Gram negative bacteria. A possible explanation for the selective toxicity of Gram positive bacteria relates to the limited iron import pathways available to Gram positive bacteria and to the known capacity of copper to compete with iron in binding to certain cell wall siderophores. Gram negative bacteria have an external cell membrane that is lacking in Gram positive bacteria. This outer membrane has various iron absorbing receptors that are absent from Gram positive bacteria. At higher concentrations, copper is bacteriocidal for Gram negative bacteria, probably again by reason of competition with iron, an essential nutrient for virtually all bacteria. For example, copper sulfate is included as an all purpose disinfectant.

Not considered in the prior art is that microbial colonization of environmental surfaces is itself a competitive process with the vast majority of environmental bacteria have little or no potential pathogenic activity even for humans and animals with underlying illnesses. Therefore, rather than directly efforts to create a sterile environment, it would seem prudent to use procedures to help favor non-pathogenic bacteria. In the face of an impeding epidemic of toxic, and potentially multi-drug resistant MRSA, a disinfectant that was at least somewhat selective to Gram positive bacteria, including MRSA, would be of benefit.

Electrolysis generated copper ions have been used in conjunction with the co-production of silver ions to disinfect water supplies. In direct testing, copper ions are less potent as an anti-bacterial agent than silver ions, especially in assays using Gram negative bacteria. Indeed, copper ions may partially compete with silver ions in some of these assays. Copper sulfate is used as an antibacterial As noted above, electrolysis of silver into a solution of citric acid has been successfully used to create a silver based disinfectant with broad antibacterial activity. The amount of silver citrate formed is determined by the concentration of citric acid used up to its maximum solubility in water and by the levels of voltage and amperes applied. Silver electrodes were used as both the cathode and anode. Again, it was mentioned that silver citrate was considered preferable to copper citrate or to a possible copper silver mixture with no claim being made for using a copper citrate containing solution.

### BRIEF DESCRIPTION OF THE DRAWINGS (FIGURES)

None

### BRIEF SUMMARY OF THE INVENTION

The invention provides a copper citrate solution that has antibacterial properties against MRSA and other bacteria. It is provided by electrolysis of copper into a solution of citric acid. By co-electrolysis of silver into the same solution, various ratios of organically bound copper to silver atoms can be generated. The levels of anti-bacterial action achieved by electrolysis of copper in citric acid is greater than that achieved using the relatively water insoluble copper citrate. Another potential carboxylate carrier of the electrolysis generated copper ions is ascorbic acid. The electrolysis generated copper and/or mixed copper-silver solutions can be used to help in the disinfection of the environment with a preferential activity against Gram positive bacteria, including MRSA.

### DETAILED DESCRIPTION OF THE INVENTION

A 5% solution of citric acid was placed into copper vessels and an anode electrode attached to the rim of the vessel. The 100% copper vessels were manufactured by West Bend Aluminum Company, West Bend, Wis., USA. A graphite cathode was placed inside the vessel beneath the surface of the citric acid solution but well away from the bottom and sides of the vessel. A direct current of 22 volts and 2.8 amps was applied between the cathode and anode and electrolysis allowed to proceed for 2 hours at room temperature. The resulting blue solution was filtered and diluted 1 to 10 in water before testing for anti-MRSA activity. In one protocol, the diluted copper citrate solution was applied to several dried surface areas that had been previously swabbed with an MRSA containing broth solution. The treated areas were allowed to dry over the next 30 minutes. An MRSA selective agar medium was then used to survey the areas for residual MRSA (MEC DD Checker Plates obtained from Denka Seiken, Inc., Japan). For control, similarly contaminated areas were either left untreated or exposed to the original starting 5% citric acid solution. Whereas, no bacterial growth occurred from the areas treated with the diluted copper citrate solution, numerous MRSA colonies developed on the plates used to sample the untreated areas and the areas exposed to citric acid. Anti-MRSA activity was also produced using a sodium citrate solution rather than citric acid and also by simply using freshly squeezed lemon juice. The experiment with citric acid was also repeated using a different power supply (9.8 volts and 2 amps) and it also produced a copper citrate solution with anti-MRSA activity. The copper citrate solutions showed no signs of toxicity when applied to human skin with no subsequent washing over the ensuring 24 hours.

It is recognized that there may possibly be some strains of MRSA bacteria that are less sensitive to killing by copper citrate solution that the strain used in the above experiment. It is also recognized that among Gram negative bacteria, many will be more tolerant of copper citrate than are Gram positive Staphylococcus aureus. This consideration is actually seen as an advantage in some situations over the use of silver solutions and other broadly based disinfecting solutions. The advantage stems from the competition between non-pathogenic and pathogenic bacteria in many environmental settings. For example and for the purpose of this patent application, the environment includes various body surfaces, which can harbor MRSA along with non-pathogenic normal microbial flora. Relatively, selective elimination of Gram positive bacteria, including MRSA, while retaining normal flora is clearly preferable to eliminating all bacteria from the skin and mucosal surfaces.

For commercial production of copper citrate, a large glass vessel containing from 3-35% citric acid, and preferentially about 10%, will be used with 100% copper and graphite electrodes separated by up to 1 meter and connected to a power supply capable of delivering up to 60 amps. The solution will be magnetically stirred to evenly distribute the released copper ions. Deposition of copper will occur on the graphite cathode but this can be periodically reversed by simply using a fresh graphite cathode and connecting the original cathode to the anode of the power supply unit. The concentration of copper ions and copper citrate can be monitored using atomic absorption analysis and gas chromatography-mass spectroscopy. For the production of a mixed copper and silver citrate, a silver electrode can be used in addition to the copper electrode, with the power supply to each electrode being differentially regulated. The resulting solutions can be tested for antibacterial activity against MRSA and other bacteria of interest. The copper citrate and copper/silver citrate combinations can be used combined with other components to prepare a variety of disinfection products, as will be apparent to anyone experienced in this field.

The principle of using a disinfectant that shows desired relative selectivity for particular types of pathogens has a wide range of potential applications. The product described in this invention is likely to have preferential activity against other Gram positive bacteria such as Clostridium difficile, Streptococcus and Listeria monocytogenes. Moreover, non-pathogenic copper resistant microorganisms could potentially be seeded in areas of the environment as a natural competitor for copper sensitive pathogenic microbes, in much the same way that pesticides are used to kill weeds in the presence of pesticide resistant crops. Various copper compounds are included among the Environmental Protection Agency (EPA) approved pesticides. Copper compounds are also widely used as anti-fouling paints for boats. EPA has classified the levels of copper compounds in widespread use as being essentially non-toxic to humans. The embodiment and modes of operation of the present invention is not to be construed as limited to the particular form disclosed, since it is to be regarded as illustrative rather than restrictive. Additional advantages and modifications will readily occur to those skilled in the art. Variations and changes may be made without departing from the spirit and principle of the invention

What we claim as our invention is:

1. A liquid composition to reduce the levels of pathogenic bacteria on environmental surfaces comprising a solution of copper citrate containing a sufficient concentration of copper to inhibit the growth of at least some methicillin resistant Staphylococcus aureus (MRSA).

2. A method of preparing the composition of claim 1 comprising electrolytically generating copper ions in a solution of citric acid, sodium citrate or lemon juice, to achieve a sufficiently high concentration of copper citrate to inhibit the growth of at least some methicillin resistant Staphylococcus aureus (MRSA).

3. A method of using the composition of claim 1 comprising applying the composition of claim 1 to an environmental surface, or to the air and liquid that will come into contact with the environmental surface, in a manner that will achieve contact between the composition and any pathogenic bacteria present on the environmental surface, including methicillin resistant Staphylococcus aureus (MRSA), so as to reduce the level of such pathogenic bacteria on the environmental surface.

4. The composition of claim 1 in which the environmental surfaces specifically includes the surface areas of both humans and animals, including the mucosal lining of the nasal and oral cavities.

5. The composition of claim 1 used in combination with varying concentrations of silver citrate to provide solutions with broader reactivity against all bacteria while still maintaining a relative selectivity against more copper sensitive bacteria, including MRSA and other Gram positive pathogens.

6. The compositions of claim 1 used in combination with various carriers, such as creams and gels, with and without the addition of surfactants and/or emulsifying agents, to facilitate application to, and retention by, various environmental surfaces included in claims 1 and 3.

7. The method of claim 2 in which electrolysis is performed in a copper vessel containing a 5% citric acid solution using a power supply providing 22 volts and 2.8 amps between the copper and a graphite electrode for two hours at room temperature.

8. The method of claim 4 in which a silver electrode is included within the citric acid, sodium citrate and/or lemon juice solutions in parallel with the copper electrode with an adjustable voltage and/or amperage supply to regulate the relative concentrations of copper and silver citrate and by inference the relative disinfecting activity against selected pathogens versus all bacteria.
